(19) United States
(12) Patent Application Publication
(10) Pub. No.: US 2014/0380295 A1
(43) Pub. Date: Dec. 25, 2014

(54) METHOD AND SYSTEM FOR UPDATING APPLICATION, AND COMPUTER STORAGE MEDIUM THEREOF

(71) Applicant: TENCENT TECHNOLOGY (SHENZHEN) COMPANY LIMITED, Shenzhen City (CN)

(72) Inventors: Xiaobo CHEN, Shenzhen City (CN); Wei YI, Shenzhen City (CN); Bin LI, Shenzhen City (CN)

(73) Assignee: TENCENT TECHNOLOGY (SHENZHEN) COMPANY LIMITED

(21) Appl. No.: 14/479,880

(22) Filed: Sep. 8, 2014

Related U.S. Application Data
(63) Continuation of application No. PCT/CN2014/071309, filed on Jan. 24, 2014.

(30) Foreign Application Priority Data
Jun. 4, 2013 (CN) 201310219154.5

(51) Int. Cl. G06F 9/445; G06F 9/44

(52) U.S. Cl. CPC G06F 8/65; G06F 8/71
USPC 717/170

(57) ABSTRACT

A method for updating software application includes: receiving version information that is uploaded by terminals; obtaining latest version information of the software application, and comparing the uploaded version information with the latest version information for obtaining added updating information; and distributing the added updating information to the terminal, the application on the terminal is updated according to the added updating information. A corresponding system for updating software application and computer storage medium is provided as well.

### CROSS-REFERENCE TO RELATED APPLICATIONS

The present application is a continuation application of International Application PCT/CN2014/071309, and claims foreign priority to Chinese application 201310219154.5 filed Jun. 4, 2013, and which are incorporated herein by reference in their entireties.

### FIELD OF THE INVENTION

The present disclosure relates generally to the field of updating software, and particularly, to a method and system and corresponding computer storage medium for updating software applications.

### BACKGROUND OF THE INVENTION

Applications with various functions are provided on third-party application markets or websites from which users may be able to download the applications and have them installed in their electronic devices such as smart terminals. New versions of the applications are released for modifying existing functions or providing new functions thereof. It is thereby necessary for the users to upgrade their installed applications to get new versions of the applications.

Typically, for updating applications, popup windows are provided when users are using the applications, reminding users to upgrade the application and directing the users to third-party application markets or particular websites. Users may download the new versions of the applications and thereby install the applications for the update. However, drawbacks might be accompanied with the conventional ways of updating. Every updating of the application is like a brand new installation which needs to download a new version for the installation. Even though there are little application files to be updated, it would be needed to download the full file of the new version, consuming a lot of the network dataflow. Update of the application would depend on the third-party application markets while many examinations would be required. Usually a rather long time would be needed for the new version of the applications to be available on the third-party application markets from the time it is published. New versions would thereby not be able to be pushed to the users in time.

### SUMMARY OF THE INVENTION

Accordingly, it is necessary to provide a method, a system, and corresponding computer storage medium for updating application.

A method for updating application includes:

receiving version information that is uploaded by terminals;

obtaining latest version information of the application, and comparing the uploaded version information and the latest version information for obtaining added updating information;

distributing updating information to the terminal, the application on the terminal is updated according to the updating information.

A system for updating application includes:

a receiving module for receiving version information that is uploaded by terminals;

a comparison module for obtaining latest version information of the application, and comparing the uploaded version information and the latest version information for obtaining added updating information;

a distribution module for distributing updating information to the terminal; the application on the terminal is updated according to the updating information.

A computer storage medium for storing computer and/or mobile terminal executable program, wherein the executable program is used for controlling the computer and/or mobile terminal to perform a method for updating applications, the method includes:

receiving version information that is uploaded by terminals;

obtaining latest version information of the application, and comparing the uploaded version information and the latest version information for obtaining added updating information;

distributing updating information to the terminal, the application on the terminal is updated according to the updating information.

The above method and system for updating application and the corresponding computer storage medium compare the uploaded version information of the application with the latest version information after receiving the version information of the application which is uploaded to/downloaded by the terminal, and obtain the added updating information. Added updating information is thereby distributed to the terminals for the terminals to update the application according to the added updating information. Only the added updating information is needed to be distributed instead of distributing the whole edition of the file corresponding to the latest version of the application, which largely reduces the data that needs to be distributed while saves the network dataflow.

### BRIEF DESCRIPTION OF THE DRAWINGS

FIG. 1 is a flow diagram of a method for updating applications according to an exemplary embodiment;

FIG. 2 is a flow diagram for obtaining the added updating information in accordance with an embodiment;

FIG. 3 is a flow diagram of a method for updating application in accordance with another embodiment;

FIG. 4 is a flow diagram of a method for updating application according to another embodiment;

FIG. 5 is a block diagram of a system for updating application according to an embodiment;

FIG. 6 is a block diagram of the comparison module 540 of FIG. 5; and

FIG. 7 is a block diagram of a computing system in accordance with an exemplary embodiment of the present invention.

### DESCRIPTION OF THE PREFERRED EMBODIMENTS

The following embodiments and accompanying drawings would be described in detail for explaining the method and apparatus for updating applications in accordance with the present disclosure.

Referring to FIG. 1, a method for updating applications according to an exemplary embodiment is illustrated. The method for updating applications is operated on servers and corresponding terminals. The terminals could be smart phones, tablets, e-book readers, laptop computers, and desktop computers, etc. The method includes steps as described below.

Step S102, receiving version information that is uploaded to/downloaded by terminals.

In detail, applications include main programs and update executive file(s). As a user downloads an application from a third-party application market and have the application installed on a terminal, the update executive file would be residentially operated (a function of, or a function residing in, the software application) on the terminal as a daemon process. The daemon process timely checks any new version of the application, and downloads and installs updating versions, while there would not be a need to update the new versions through third-party application markets.

The daemon process timely sends the version information of the application to the server; and the server receives the version information accordingly. The timing could be set when needed, for example, 12 hours or 24 hours, etc. The version information may be version number, such as Version A.

Step S104, obtaining latest version information of the application, and comparing the uploaded version information and the latest version information for obtaining added updating information.

Each version of the distributed applications would have corresponding installation file and configuration information stored on the server, which means the server would store a mapping relationship between the version number and corresponding installation file and configuration information.

The server receives the version information that is uploaded by the terminal, the latest version information of the application would be found from the server according to the stored mapping relationship. The uploaded version information is compared with the latest version information accordingly. If the uploaded version information is deemed identical to (matches) the latest version information, the updating information would be null; otherwise if a difference is found, the added updating information could be obtained. Different added updating information would be obtained according to different uploaded version information as compared with the latest version information.

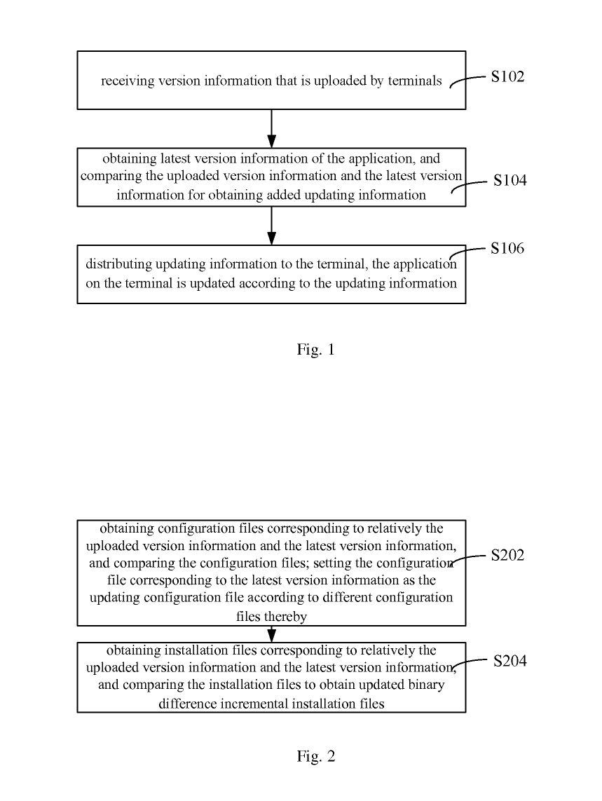

The updating information includes updating configuration file and binary difference incremental installation file. Referring to FIG. 2, a flow for obtaining the added updating information in accordance with an embodiment is shown.

Step S202, obtaining configuration files corresponding to the respective uploaded version information and the latest version information, and comparing the configuration files; setting the configuration file corresponding to the latest version information as the updating configuration file according to different configuration files thereby.

In detail, message digests could be compared for comparing the configuration files. Message digests of the corresponding configuration files would be respectively computed, and subsequently compared. If there is a difference between the message digests, the configuration file corresponding to the latest version information is set as the updating configuration file. Besides, at the server an updating list would be able to be preset, and the updating configuration file is added to the updating list. The configuration file is a non-executable file, for example, text, picture, or audio files, etc.

Step S204, obtaining installation files corresponding to the uploaded version information and the latest version information, and comparing the installation files to obtain updated binary difference incremental installation files.

In detail, added installation files that are determined through the above comparison would be transformed into binary difference incremental installation files through BSDIFF algorithm. The BSDIFF algorithm is a tool for patching binary programs and generating binary patch programs with considerable small size. Size of the binary difference incremental installation file would be far less than that of the installation file corresponding to the latest version information, while mass network dataflow could be saved during downloading process.

Step S106, distributing updating information to the terminal, the application on the terminal is updated according to the updating information.

In detail, protocols like HTTP (Hypertext transfer protocol), FTP (File transfer protocol) could be used for distributing the added updating information. After the terminal receives the distributed updating information, processes excluding the daemon process of the application is terminated, and existing installation files are overwritten through added updated installation files, and subsequently the daemon process reboots the processes that were terminated during the installation.

The above method for updating application compares the uploaded version information of the application with the latest version information after receiving the version information of the application which is uploaded by the terminal, and obtains the added updating information. Added updating information is thereby distributed to the terminals for the terminals to update the application according to the added updating information. Only the added updating information is needed to be distributed instead of distributing the whole edition of the file corresponding to the latest version of the application, which largely reduces the data that needs to be distributed while saves the network dataflow.

Referring to FIG. 3, a method for updating application in accordance with another embodiment is illustrated. The method as shown in FIG. 3 is different from the method as in FIG. 1 in that, the updating information is directly distributed only when the terminal is connected through wireless network.

Step S302, receiving version information that is uploaded by terminals.

The version information may be version number, such as Version A.

Step S304, obtaining latest version information of the application, and comparing the uploaded version information and the latest version information for obtaining added updating information.

The updating information includes updating configuration file and binary difference incremental installation file.

Step S306, if the terminal is connected through wireless network, directly distributing updating information to the terminal.

In detail, when the terminals are connected through wireless network, such as WIFI network, the server directly distributes the added updating information to the terminals, which means the terminals directly silently (without user interaction or without a user interface) detect updates of the applications and download the added updating information, while the users are not needed to trigger to choose whether to download or not.

The above method for updating application directly distributes the added updating information to the terminals through wireless network. Only the added updating information is required to be distributed instead of distributing the whole edition of the file corresponding to the latest version of the application, which largely reduces the data that needs to be distributed while saves the network dataflow. The users are not needed to trigger the updating operation, which reduces user operation and hardware consumption.

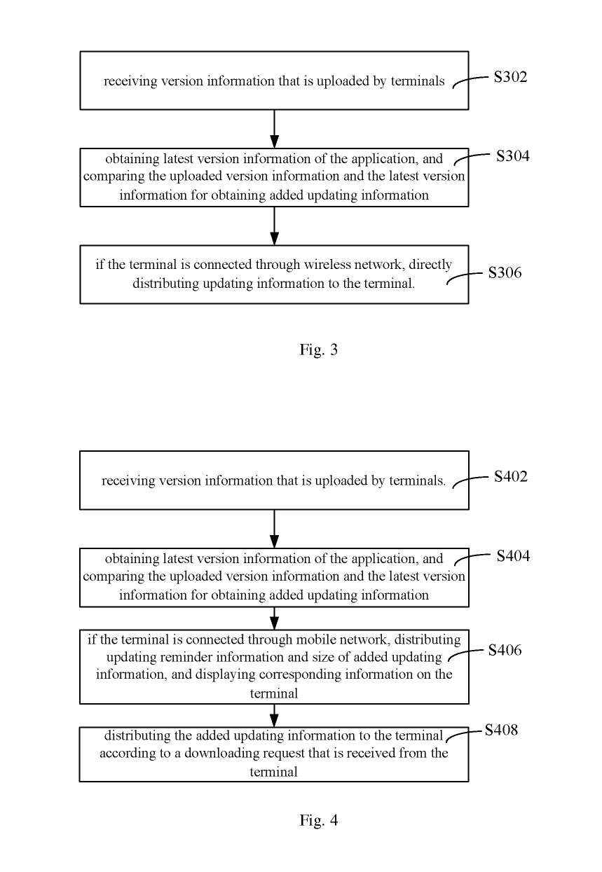

Referring to FIG. 4, a method for updating application according to another embodiment is illustrated. The method as shown in FIG. 4 is different from the method as in FIG. 1 that, the distribution of the updating information is dependent on user's choices when the terminal is connected through mobile network.

Step S402, receiving version information that is uploaded by terminals.

The version information may be version number, such as Version A.

Step S404, obtaining latest version information of the application, and comparing the uploaded version information and the latest version information for obtaining added updating information.

The updating information includes updating configuration file and binary difference incremental installation file.

Step S406, if the terminal is connected through mobile network, distributing updating reminder information and size of added updating information, and displaying corresponding information on the terminal.

The updating reminder information may include introduction to new functions, reminder flag, etc. The reminder flag could be represented by text or image, et al. The size of added updating information could be 1 MB (megabyte) etc.

Step S408, distributing the added updating information to the terminal according to a downloading request that is received from the terminal.

In detail, after the updating reminder information and the size of the added updating information is displayed on the terminal, the user may choose to download through input devices such as touch screen or keyboard. The server receives the downloading request from the terminal, and distributing the added updating information to the terminal. If the user chooses not to download, the terminal would not download the updating information from the server.

The above method for updating application determines whether to distribute the added updating information according to the user's choices when the terminals are connected through mobile network, which facilitates the operation.

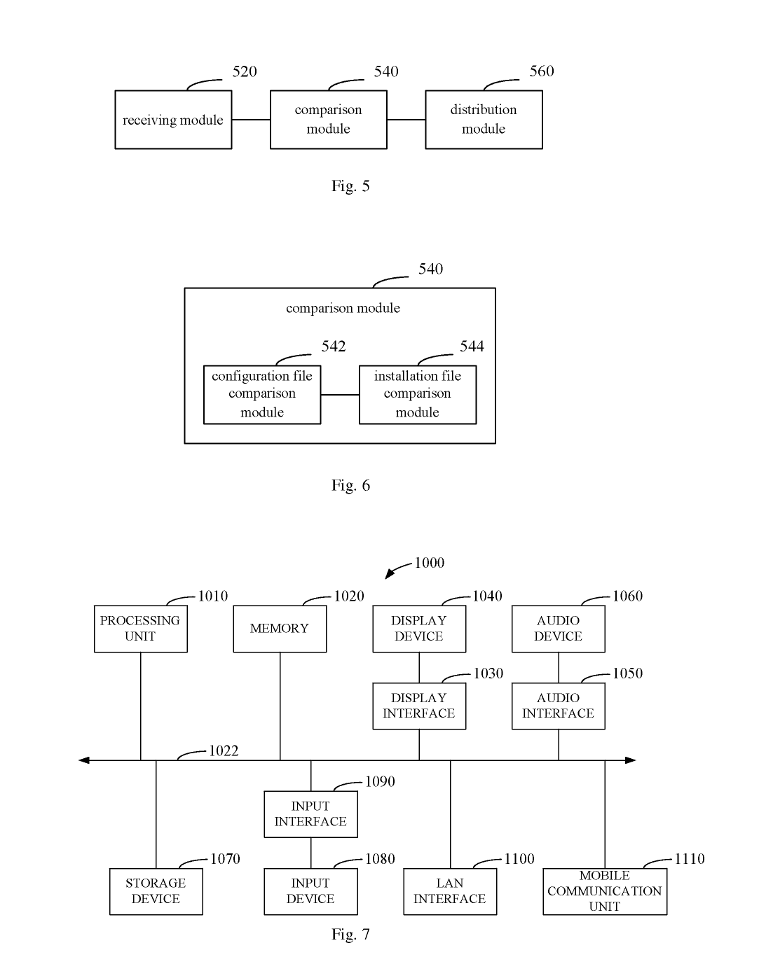

Referring to FIG. 5, a block diagram of a system for updating application is illustrated. The system for updating application could be program operating on the server, and could be defined as a plurality of functional modules according to the operation flow of the program. The system for updating application includes a receiving module 520, a comparison module 540, and a distribution module 560.

The receiving module 520 is used for receiving version information that is uploaded by terminals.

In detail, applications include main programs and update executive files. As a user downloads an application from a third-party application market and have the application installed on a terminal, the update executive file would be residentially operated on the terminal as daemon process. The daemon process timely checks any new version of the application, and downloads and installs updating versions, while there would not be a need to update the new versions through third-party application markets.

The daemon process timely sends the version information of the application to the server; and the server receives the version information accordingly. The timing could be set when needed, for example, 12 hours or 24 hours, etc. The version information may be version number, such as Version A.

The comparison module 540 is used for obtaining latest version information of the application, and comparing the uploaded version information and the latest version information for obtaining added updating information.

Each version of the distributed applications would have corresponding installation file and configuration information stored on the server, which means the server would store a mapping relationship between the version number and corresponding installation file and configuration information.

The server receives the version information that is uploaded by the terminal, the latest version information of the application would be found from the server according to the stored mapping relationship. The comparison module 540 compares the uploaded version information with the latest version information accordingly. If the uploaded version information is deemed identical to (matches) the latest version information, the updating information would be null; otherwise if a difference is found, the added updating information could be obtained. Different added updating information would be obtained according to different uploaded version information as compared with the latest version information.

The updating information includes updating configuration file and binary difference incremental installation file.

Further according to an embodiment, FIG. 6 shows a block diagram of the comparison module 540. The comparison module 540 includes a configuration file comparison module 542 and an installation file comparison module 544.

The configuration file comparison module 542 is used for obtaining configuration files corresponding to the respective uploaded version information and the latest version information, and comparing the configuration files; and for setting the configuration file corresponding to the latest version information as the updating configuration file according to different configuration files thereby.

In detail, message digests could be compared for comparing the configuration files. Message digests of the corresponding configuration files would be respectively computed, and subsequently compared. If there is difference between the message digests, the configuration file corresponding to the latest version information is set as the updating configuration file. Besides, at the server, an updating list would be able to be preset, and the updating configuration file is added to the updating list. The configuration file is a non-executable file, for example, text, picture, or audio files, etc.

The installation file comparison module 544 is used for obtaining installation files corresponding to the respective uploaded version information and the latest version information, comparing the installation files, and obtaining updated binary difference incremental installation files.

In detail, added installation files that are determined through the above comparison would be transformed into binary difference incremental installation files through BSDIFF algorithm. The BSDIFF algorithm is a tool for patching binary programs and generating binary patch programs with considerable small size. Size of the binary difference incremental installation file would be far less than that of the installation file corresponding to the latest version information, while mass network dataflow could be saved during downloading process.

The distribution module 560 is used for distributing updating information to the terminal; the application on the terminal is updated according to the updating information.

In detail, protocols like HTTP (Hypertext transfer protocol), FTP (File transfer protocol) could be used for distributing the added updating information. After the terminal receives the distributed updating information, processes excluding the daemon process of the application is terminated, and existing installation files are overwritten through added updated installation files, and subsequently the daemon process reboots the processes that were terminated during the installation.

The above system for updating application compares the uploaded version information of the application with the latest version information after receiving the version information of the application which is uploaded by the terminal, and obtains the added updating information. Added updating information is thereby distributed to the terminals for the terminals to update the application according to the added updating information. Only the added updating information is needed to be distributed instead of distributing the whole edition of the file corresponding to the latest version of the application, which largely reduces the data that needs to be distributed while saves the network dataflow.

Furthermore, according to another embodiment, the distribution module 560 is used for directly distributing updating information to the terminal if the terminal is connected through wireless network.

In detail, when the terminals are connected through wireless network, such as WIFI network, the server directly distributes the added updating information to the terminals, which means the terminals directly silently (without user interaction or without a user interface) detect updates of the applications and download the added updating information, while the users are not needed to trigger to choose whether to download or not. The users are not needed to trigger the updating operation, which reduces user operation and hardware consumption.

Furthermore, according to another embodiment, the distribution module 560 is used for distributing updating reminder information and size of added updating information, and displaying corresponding information on the terminal if the terminal is connected through mobile network. The updating reminder information may include introduction to new functions, reminder flag, etc. The reminder flag could be represented by text or image, et al. The size of added updating information could be 1 MB (megabyte) etc.

The distribution module 560 is further used for distributing the added updating information to the terminal according to a downloading request that is received from the terminal.

In detail, after the updating reminder information and the size of the added updating information is displayed on the terminal, the user may choose to download through input devices such as touch screen or keyboard. The server receives the downloading request from the terminal, and distributing the added updating information to the terminal. If the user chooses not to download, the terminal would not download the updating information from the server. The system for updating application thereby determines whether to distribute the added updating information according to the user's choices when the terminals are connected through mobile network, which facilitates the operation.

Those skilled in the art could be able to understand that the above method, whether as a whole or part thereof, would be implemented through particular hardware under the instruction of computer and/or mobile terminal executable programs; which program is stored in non-transitory computer readable medium that, the above steps of the methods would be included when the program is executed. The non-transitory computer readable medium shall include hard disk, optical disk, Read-Only Memory (ROM) or Random Access Memory (RAM), etc.

FIG. 7 shows a system block diagram of a computing system 1000 on which embodiments of the invention may be implemented. The computing system 1000 is only one example of a suitable computing environment and is not intended to suggest any limitation as to the scope of use of embodiments of the invention. Neither should the computing system 1000 be interpreted as having any dependency or requirement relating to any one or combination of components illustrated in the exemplary computing system 1000.

The computing system 1000 shown in FIG. 7 is an example of a computer system suitable for use with embodiments of the invention. Other architectures having different configurations of subsystems can also be utilized. Examples of well-known computer systems may be suitable for use with embodiments of the invention include, but are not limited to, desktop computers, laptop computers, personal digital assistants, smart phones, tablet computers, portable media players, set top boxes, and the like. According to an aspect of an embodiment, as also described herein, a unit is implemented by way of computer hardware that implements the described functions and/or is implemented by way of computer hardware that executes software instructions, which may have a modular design in form of software modules, which implement the described functions.

As in FIG. 7, the computing system 1000 includes a processing unit 1010, a memory 1020, and a system bus 1022 that couples various system components including the memory 1020 to the processing unit 1010. The processing unit 1010 is a hardware that carries out the instructions of a computer program by performing the basic arithmetical and logical operations of the computer system. The memory 1020 is a physical device used to store computer program or data (e.g. program state information) on a temporary or permanent basis. The system bus 1022 may be any of several types of bus structures including a memory bus or memory controller, a peripheral bus, and a local bus. The system bus 1022 allows data communication between the processing unit 1010 and the memory 1020, which may include read-only memory (ROM) or flash memory (neither shown), and random access memory (RAM) (not shown). The RAM is generally the main memory into which the operating system and application programs are loaded.

The computing system 1000 further includes a display interface 1030 (e.g., graphic processing unit), a display device 1040 (e.g., liquid crystal display device), an audio interface 1050 (e.g., sound card), and an audio device 1060 (e.g., speaker). The display device 1040 and the audio device 1060 are media devices used to experience multimedia content.

The computing system 1000 typically includes a storage device 1070. The storage device 1070 may be selected from a variety of computer readable media. The computer readable media can be any available media that can be accessed by the computing system 1000 and includes both removable and non-removable media. By way of example, computer readable media includes, but is not limited to, flash memory (e.g., micro SD card), CD-ROM, digital versatile disks (DVD) or other optical disk storage, magnetic cassettes, magnetic tape, magnetic disk storage or other magnetic storage devices, or any other medium which can be used to store the desired information and which can accessed by the computing system 1000.

The computing system 1000 further includes an input device 1080 and an input interface 1090 (e.g., IO controller). A user may enter commands and information into the computing system 1000 through the input device 1080 such as a keyboard, a mouse, a touch panel disposed on the display device 1040. The input device 1080 is often connected to the processing unit 1010 through the input interface 1090 that is coupled to the system bus 1022, but may be connected by other interface and bus structures, such as a universal serial bus (USB).

The computing system 1000 may operate in a networked environment using logical connections to one or more network devices. The network device may be a personal computer, a server, a router, a smart phone, a tablet computer or other common network node. The computing system 1000 connects the network device via a local area network (LAN) interface 1100 or a mobile communication unit 1110. A local area network (LAN) is a computer network that interconnects computers in a limited area such as a home, school, computer laboratory, or office building using network media. Ethernet over twisted pair cabling, and Wi-Fi are the two most common technologies currently used to build LANs. Wi-Fi is a technology that allows the computing system 1000 to exchange data or connect to the internet wirelessly using radio waves. The mobile communication unit 1110 can make and receive telephone calls over a radio link while moving around a wide geographic area, for example, a mobile cellular wireless network, satellite network. In addition to telephony, the mobile communication unit 1110 also supports internet access by providing mobile data service on the 2G, 3G, or 4G cellular communication systems.

It should be noted that, in other computing systems suitable for use with the invention, the computing system may include additional or fewer subsystems. For example, another computing system could include a Bluetooth unit for exchanging data over short distances, an image sensor for photography, and an accelerometer for measuring acceleration.

As described in detail above, the computing system 1000, consistent with the present invention, perform certain operations for a method for updating applications. The computing system 1000 may perform these operations in response to the processing unit 1010 executing software instructions contained in the computer readable media. The software instructions may be read into the memory 1020 from the storage device 1070, or from another device via the LAN interface 1100. The software instructions contained in the memory 1020 causes the processing unit 1010 to perform the method for updating applications described above. Alternatively, hardwired circuitry may be used in place of or in combination with software instructions to implement processes consistent with the present invention. Thus, the present invention is not limited to any specific combination of hardware circuitry and software.

The above described embodiments explain only several exemplary embodiments of the present disclosure. It shall be mentioned that for those skilled in the art, alternative embodiments could be made to which the present disclosure pertains without departing from its spirit and scope, wherein the alternative embodiments shall be defined as within the claim of the current disclosure.

What is claimed is:

1. A method for updating software application, comprising:
receiving, by a server computer, uploaded version information of a software application uploaded by terminals as uploaded software applications;
obtaining, by the server computer, latest version information of the software application, and comparing the uploaded version information of the uploaded software applications with the latest version information of the software application for obtaining added updating information for the uploaded software applications;
distributing, by the server computer, the added updating information for the uploaded software applications to the terminals, thereby the uploaded software applications of the terminals updated according to the added updating information for the uploaded software applications.

2. The method according to claim 1, wherein the obtaining latest version information of the software application, and comparing the uploaded version information of the uploaded software applications with the latest version information of the software application for obtaining added updating information for the uploaded software applications further comprises:
obtaining, by the server computer, configuration files respectively corresponding to the uploaded version information of the uploaded software applications and the latest version information of the software application, comparing respectively the obtained configuration files, and setting the configuration file corresponding to the latest version information of the software application as updating configuration files for the uploaded software applications, if the obtained configuration files are different according to the respective comparisons;
obtaining, by the server computer, installation files respectively corresponding to the uploaded version information of the uploaded software applications and the latest version information of the software application, and comparing respectively the obtained installation files to obtain respective corresponding updating binary difference incremental installation files;
wherein the added updating information for the uploaded software applications comprise the obtained updating configuration files and updating binary difference incremental installation files.

3. The method according to claim 1, wherein after obtaining latest version information of the software application, and comparing the uploaded version information of the uploaded software applications with the latest version information of the software application, the method further comprises:
if an uploaded version information of an uploaded software application matches the latest version information of the software application, determining an added updating information to be null.

4. The method according to claim 1, wherein after obtaining latest version information of the software application, and comparing the uploaded version information of the uploaded software applications with the latest version information of the software application for obtaining added updating information, the method further comprises:
if a terminal is connected through a wireless network, directly distributing, by the computer server, the added updating information to the terminal.

5. The method according to claim 1, wherein after obtaining latest version information of the software application, and comparing the uploaded version information of the uploaded software applications with the latest version information of the software application for obtaining added updating information, the method further comprises:
if a terminal is connected through a mobile network, distributing, by the computer server, updating reminder information and size of the added updating information to cause displaying corresponding information on the terminal for the updating reminder information and the size of the added updating information;
distributing, by the server computer, the added updating information to the terminal according to a downloading request that is received from the terminal.

6. A system for updating a software application comprising:
computer hardware in combination with non-transitory computer readable storage medium which stores instructions that when executed by the computer hardware implement modules of:
a receiving module to receive version information of a software application uploaded by terminals as uploaded software applications;
a comparison module to obtain latest version information of the software application, and compare the uploaded version information of the uploaded software applications with the latest version information of the software application for obtaining added updating information for the uploaded software applications;
a distribution module to distribute the added updating information for the uploaded software applications to the terminals, thereby the uploaded software applications of the terminals updated according to the added updating information for the uploaded software applications.

7. The system according to claim 6, wherein the comparison module comprises:
a configuration file comparison module to obtain configuration files respectively corresponding to the uploaded version information of the software applications and the latest version information of the software application, comparing respectively the obtained configuration files, and setting the configuration file corresponding to the latest version information of the software application as updating configuration file for the uploaded software applications, if the obtained configuration files are different according to the respective comparisons;
an installation file comparison module to obtain installation files respectively corresponding to the uploaded version information of the uploaded software applications and the latest version information of the software application, and comparing respectively the obtained installation files to obtain respective corresponding updating binary difference incremental installation files;
wherein the added updating information for the uploaded software applications comprise the obtained updating configuration files and updating binary difference incremental installation files.

8. The system according to claim 6, wherein the comparison module determines an added updating information to be null if an uploaded version information of an uploaded software application matches the latest version information of the software application.

9. The system according to claim 6, wherein the distribution module directly distributes the added updating information to a terminal if the terminal is connected through a wireless network.

10. The system according to claim 6, wherein the distribution module is further configured to:
distribute updating reminder information and size of the added updating information to cause display of corresponding information on the terminal for the updating reminder information and the size of the added updating information, if a terminal is connected through a mobile network; and
distribute the added updating information to the terminal according to a downloading request that is received from the terminal.

11. A non-transitory computer storage medium for storing computer and/or mobile terminal executable program, wherein the executable program is used for controlling a server computer to perform a method for updating software applications uploaded on the terminals, the method comprising:
receiving, from the terminals, version information of a software application uploaded by the terminals as uploaded software applications;
obtaining latest version information of the software application, and comparing the uploaded version information of the uploaded software applications with the latest version information of the software application for obtaining added updating information for the uploaded software applications;
distributing the added updating information for the uploaded software applications to the terminals, thereby the uploaded software applications of the terminals updated according to the added updating information for the uploaded software applications.

12. The non-transitory computer storage medium according to claim 11, wherein the obtaining of the latest version information of the software application, and comparing the uploaded version information of the uploaded software applications with the latest version information of the software application for obtaining added updating information for the uploaded software applications further comprises:
obtaining configuration files respectively corresponding to the uploaded version information of the uploaded software applications and the latest version information of the software application, comparing respectively the obtained configuration files, and setting the configuration file corresponding to the latest version information of the software application as updating configuration file for the uploaded software applications, if the obtained configuration files are different according to the respective comparisons;
obtaining installation files respectively corresponding to the uploaded version information of the uploaded software applications and the latest version information of the software application, and comparing respectively the obtained installation files to obtain respective corresponding updating binary difference incremental installation files;
wherein the added updating information for the uploaded software applications comprise the obtained updating configuration files and updating binary difference incremental installation files.

13. The non-transitory computer storage medium according to claim 11, wherein after obtaining latest version information of the software application, and comparing the uploaded version information of the uploaded software applications with the latest version information of the software application, the method further comprises:
if an uploaded version information of an uploaded software application matches the latest version information of the software application, determining an added updating information to be null.

14. The non-transitory computer storage medium according to claim 11, wherein after obtaining latest version information of the software application, and comparing the uploaded version information of the uploaded software applications with the latest version information of the software application for obtaining added updating information, the method further comprises:
if a terminal is connected through a wireless network, directly distributing the added updating information to the terminal.

15. The non-transitory computer storage medium according to claim 11, wherein after obtaining latest version information of the software application, and comparing the uploaded version information of the uploaded software applications with the latest version information of the uploaded software applications for obtaining added updating information, the method further comprises:
if a terminal is connected through a mobile network, distributing updating reminder information and size of the added updating information to cause displaying corresponding information on the terminal for the updating reminder information and the size of the added updating information;
distributing the added updating information to the terminal according to a downloading request that is received from the terminal.
